(19) United States
(12) Patent Application Publication
(10) Pub. No.: US 2012/0120025 A1
(43) Pub. Date: May 17, 2012

(54) ELECTRONIC DEVICE AND METHOD FOR TEXT INPUT

(75) Inventors: WEI WU, Shenzhen City (CN); XIN YANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/163,720

(22) Filed: Jun. 19, 2011

(30) Foreign Application Priority Data
Nov. 11, 2010 (CN) 201010539826.7

(51) Int. Cl. G06F 3/042; G06F 3/043

(52) U.S. Cl. 345/175; 345/177

(57) ABSTRACT

An input text correcting method is applied to an electronic device. The method includes detecting whether a display is touched, recording sound generated by friction between a touching finger and the display when the display is being touched, comparing the recorded sound with the one or more standard sounds. Determining a touch operation on a touch area is an erasing operation and further determining display text in the touch area when the recorded sound matches the one or more standard sounds, and erasing the display text in the touch area. An electronic device for implementing the input text correcting method is also provided.

### BACKGROUND

1. Technical Field

The present disclosure relates to electronic devices with text input function, and more particularly, to an electronic device and a method with input editing interface for correcting input texts.

2. Description of Related Art

Text inputs may be corrected on a touch-sensitive display by making a sliding, swiping, or other finger gestures. By this way, a number of characters proportional to a distance (e.g., a linear distance) of the finger gesture crossing the display are erased.

However, a traditional method to correct text input needs to identify the gesture and calculate the distance of the finger gesture, therefore the display needs high-accuracy.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of one embodiment of an electronic device in accordance with the present disclosure.

FIG. 2 is a display diagram of a display area of one embodiment of the electronic device of FIG. 1 covered by a finger movement.

FIG. 3 is a display diagram of displaying text in the display area of FIG. 2.

FIG. 4 is a display diagram of new text input in the display area of FIG. 2

FIG. 5 is a flowchart of one embodiment of method of correcting input text in accordance with the present disclosure.

### DETAILED DESCRIPTION

Embodiments of the present disclosure will now be described in detail below, with reference to the accompanying drawings.

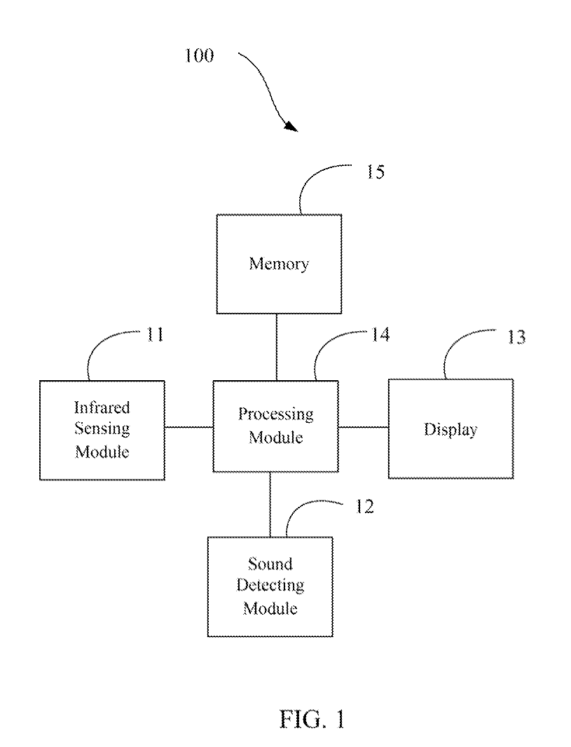

FIG. 1 is a block diagram of one embodiment of an electronic device 100 in accordance with the present disclosure.

The electronic device 100 may be a portable device with text input function, computer, mobile phone or PDA, for example.

In an embodiment, the electronic device 100 includes an infrared sensing module 11, a sound detecting module 12, a display 13, a processing module 14, and a memory 15. The infrared sensing module 11, the sound detecting module 12, the display 13 and the memory 15 are electronically connected with the processing module 14.

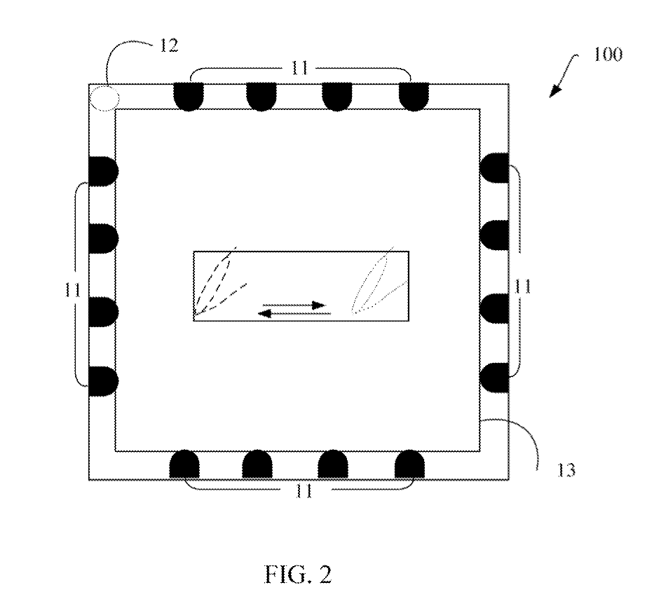

The infrared sensing module 11 is installed around the display 13, for sensing a finger touch on the display 13. The infrared sensing module 11 may include a plurality of infrared emitting devices and infrared receiving devices, which are placed in pairs for detecting infrared light emitted by the light emitting devices. As shown in FIG. 2, a linear array of light detecting devices is positioned on two adjacent sides of the display 13. Each of the infrared receiving devices detects infrared light emitted from one of the light emitting devices, which faces the paired infrared receiving device, thereby, a light path is formed between each pair of the infrared receiving device and a corresponding infrared emitting device. In parallel direction, all the light paths formed between the infrared emitting devices and corresponding infrared receiving devices are substantially parallel; in a vertical direction, all the light paths formed between the infrared emitting devices and infrared receiving devices placed in pairs are also substantially parallel. When a touch operation is implemented on the display 13, two light paths whose intersection is on the touch point are blocked, thereby the location of the intersection is determined. A touch area which is covered by the touch operation is determined according to locations of multi-intersections.

The sound detecting module 12 detects and records the sounds generated by friction between touching finger and the display 12 when the touch operation is implemented on the display 13. The sound detecting module 12 may be installed in one corner of the display 13 or any position around the display 13.

The memory 15 supplies space for data and one or more standard sounds which are generated by friction between the touching finger and the display 13 when implementing an erasing operation.

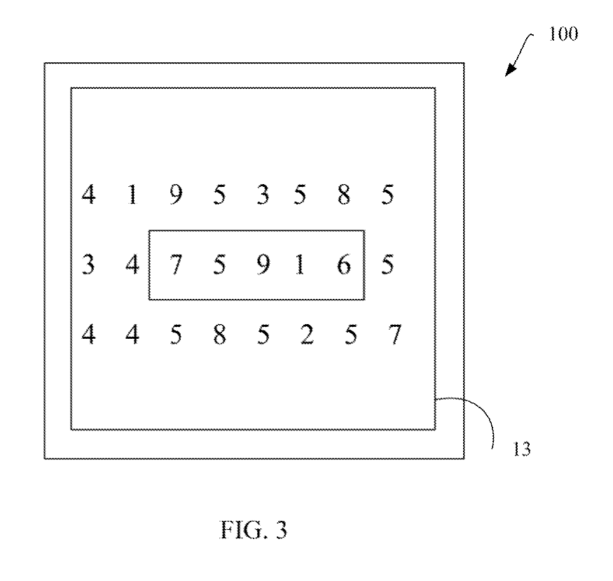

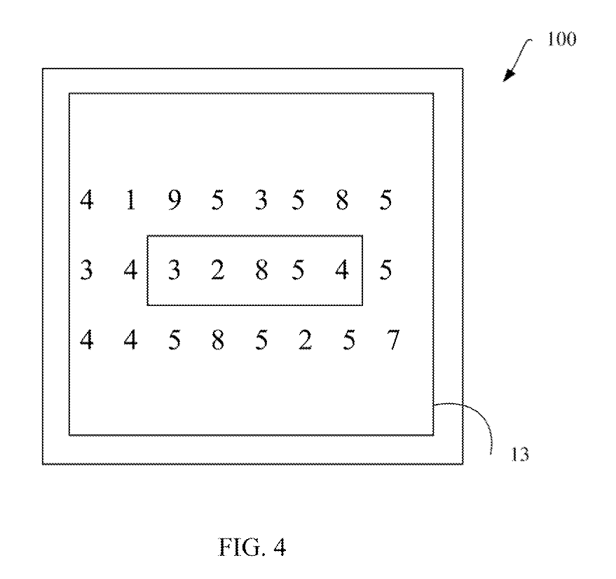

The processing module 14 compares the sounds recorded by the sound detecting module 12 with the one or more standard sounds. When the sound recorded by the sound detecting module 12 matches the one or more standard sounds, the processing module 14 determines the touch operation on the touch area is the erasing operation and further determines display text in the touch area, and erases the display text in the touch area. The processing module 14 also input new text in the touch area after erasing the display text. As shown in FIG. 3, the display text in the display area is “7 5 9 1 6”. As shown in FIG. 4, the display text “7 5 9 1 6” is erased, and new text of “3 2 8 5 4” is input.

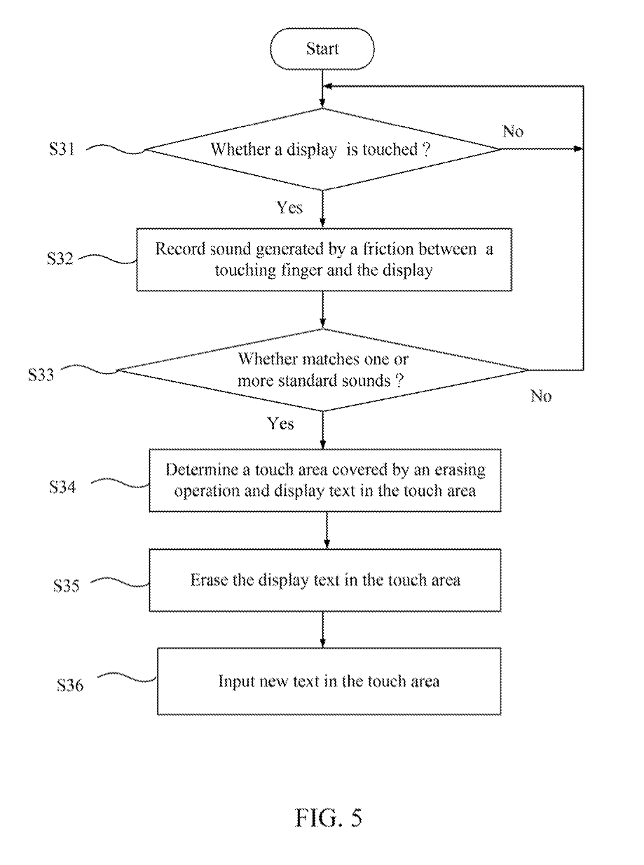

FIG. 5 is a flowchart of one embodiment of method of correcting input text in accordance with the present disclosure.

In step S31, the infrared sensing module 11 detects whether the display 13 is touched, if yes, the procedure goes to step S32, if no, the procedure repeats the step S31.

In step S32, the sound detecting module 12 records the sounds generated by the friction between the finger and the display 12.

In step S33, the processing module 14 compares the sound recorded by the sound detecting module 12 with the one or more standard sounds, whether the sound recorded by the sound detecting module 12 matches the one or more standard sounds, the procedure goes to step S34, if no, the procedure returns to step S31.

In step S34, the processing module 14 determines the touch operation on the touch area is the erasing operation and further determines the displayed text in the touch area.

In step S35, the processing module 14 erases the displayed text in the touch area.

In step S36, the processing module 14 inputs new text in the touch area after erasing the displayed text.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. An input text correcting method of an electronic device, the method comprising:
detecting whether a display is touched;
recording sound generated by friction between a touching finger and the display when the display is being touched;
comparing the recorded sound with one or more standard sounds;
determining a touch operation on a touch area is an erasing operation and further determining display text in the touch area whether the recorded sound matches the one or more standard sounds; and
erasing the display text in the touch area.

2. The input text correcting method as claimed in claim 1, wherein the method further comprises: inputting new text in the touch area after erasing the display text.

3. The copyright protection method of audio files as claimed in claim 1, wherein the step of determining a touch operation on a touch area is an erasing operation and further determines display text in the touch area whether the recorded sound is consisted with the one or more standard sounds further comprises: determining a location of an intersection of two light paths which are blocked, and thereby determining the touch area which is covered by the erasing operation according to the locations of multi-intersections.

4. The copyright protection method of audio files as claimed in claim 1, wherein the one or more standard sounds is pre-stored in a memory.

5. An electronic device for implementing an input text correcting method, the electronic device comprising:
an infrared sensing module, for detecting whether a display is touched;
a sound detecting module, for recording sound generated by friction between a touching finger and the display when the display is being touched; and
a processing module, for comparing the recorded sound with one or more standard sounds, determining a touch operation on a touch area is an erasing operation and further determines display text in the touch area whether the recorded sound matches the one or more standard sounds; and erasing the display text in the touch area.

6. The electronic device as claimed in claim 1, wherein the electronic device further comprises a memory for supplying a space for data and the one or more standard sounds.

7. The electronic device as claimed in claim 1, wherein the processing module is further configured for inputting new text in the touch area after erasing the display text.

8. The electronic device as claimed in claim 1, wherein the processing module is further configured for determining a location of an intersection of two light paths which are blocked, and thereby determining the touch area which is covered by the erasing operation according to the locations of multi-intersections.

9. The electronic device as claimed in claim 1, wherein the sound detecting module is installed in one corner of the display or any position around the display.

10. The electronic device as claimed in claim 1, wherein the infrared sensing module is installed around the display.

11. The electronic device as claimed in claim 10, wherein the infrared sensing module comprises a plurality of infrared emitting devices and infrared receiving devices which are placed in pairs for detecting infrared light emitted by the light emitting devices, a linear array of light detecting devices is positioned on two adjacent sides of the display, each of the infrared receiving devices detects infrared light emitted from one of the light emitting devices which faces the paired infrared receiving device, thereby, a light path is formed between each pair of the infrared receiving device and corresponding infrared emitting device; in parallel direction, all the light paths formed between the infrared emitting devices and corresponding infrared receiving devices are substantially parallel; in vertical direction, all the light paths formed between the infrared emitting devices and infrared receiving devices placed in pairs are also substantially parallel.
